(19) United States
(12) Patent Application Publication
(10) Pub. No.: US 2018/0032351 A1
(43) Pub. Date: Feb. 1, 2018

(54) INFORMATION PROCESSING METHOD AND STORAGE DEVICE

(71) Applicant: Lenovo (Beijing) Co., Ltd., Beijing (CN)

(72) Inventor: Haiyang HE, Beijing (CN)

(21) Appl. No.: 15/664,038

(22) Filed: Jul. 31, 2017

(30) Foreign Application Priority Data
Jul. 29, 2016 (CN) 201610615799.4
Jul. 29, 2016 (CN) 201610619978.5

(51) Int. Cl. G06F 9/44; G06F 3/06

(52) U.S. Cl. CPC G06F 9/4411; G06F 3/0679; G06F 3/065; G06F 3/0619; G06F 3/0644

(57) ABSTRACT

The present disclosure provides an information processing method. The method includes installing a first operating system; generating a first boot variable based on a boot code corresponding to the first operation system; and storing the first boot variable and the boot code in a first removable storage medium of the electronic apparatus.

### CROSS-REFERENCES TO RELATED APPLICATIONS

This application claims priority to Chinese Patent Application No. 201610615799.4, filed on Jul. 29, 2016, and Chinese Patent Application No. 201610619978.5, filed on Jul. 29, 2016, the entire contents of which are incorporated herein by reference.

### TECHNICAL FIELD

The present disclosure relates to the field of information technology and, more particularly, to an information processing method, and a related storage device.

### BACKGROUND

Some operating systems, such as the Unified Extensible Firmware Interface (UEFI) operating system, after being installed, can generate a UEFI bootstrap variable in the flash memory of the UEFI to record the storage path of the bootloader for the UEFI operating system. The UEFI boot variable also records the name of the operating system.

Since the UEFI boot variable is stored in the flash memory of the UEFI, when the storage medium storing the operating system code and the boot code is moved to another electronic device (e.g., the electronic apparatus A), the flash memory of the UEFI of the electronic device (apparatus A) does not contain the UEFI bootstrap variable. Consequently, the boot code of the UEFI operating system may not be found to boot the UEFI operating system.

### BRIEF SUMMARY

In accordance with some embodiments of the present disclosure, an information processing method is provided. The method includes installing a first operating system; generating a first boot variable based on a boot code corresponding to the first operation system; and storing the first boot variable and the boot code in a first removable storage medium of the electronic apparatus.

Another aspect of present disclosure provides an electronic apparatus. The electronic apparatus includes a processor; and a first removable storage medium connected to the processor. The processor is configured for: installing a first operating system on the electronic apparatus, generating a first boot variable based on a boot code corresponding to the first operation system, and storing the first boot variable and the boot code on the first removable storage medium.

Other aspects of the present disclosure can be understood by those skilled in the art in light of the description, the claims, and the drawings of the present disclosure.

### BRIEF DESCRIPTION OF THE DRAWINGS

Various objectives, features, and advantages of the present disclosure can be more fully appreciated with reference to the detailed description of the present disclosure when considered in connection with the following drawings, in which like reference numerals identify the same or like elements unless otherwise specified. That the following drawings are merely examples for illustrative purposes according to various disclosed embodiments and are not intended to limit the scope of the present disclosure.

FIG. 1 illustrates a schematic flow diagram of an exemplary method for information processing in accordance with some embodiments of the present disclosure;

FIG. 2 illustrates a schematic diagram of an exemplary Protective Master Boot Record (PMBR) in accordance with some embodiments of the present disclosure;

FIG. 3 illustrates a schematic flow diagram of another exemplary method for information processing in accordance with some other embodiments of the present disclosure;

FIG. 4 illustrates a schematic diagram of a partition of an exemplary storage medium in accordance with some embodiments of the present disclosure;

FIG. 5 illustrates a schematic flow diagram of another exemplary method for information processing in accordance with some other embodiments of the present disclosure;

FIG. 6 illustrates a schematic structural diagram of an exemplary electronic apparatus in accordance with some embodiments of the present disclosure;

FIG. 7 illustrates a schematic structural diagram of another exemplary electronic apparatus in accordance with some other embodiments of the present disclosure;

FIG. 8 illustrates a schematic structural diagram of another exemplary electronic apparatus in accordance with some other embodiments of the present disclosure; and

FIG. 9 illustrates a schematic flow diagram of another exemplary method for information processing in accordance with some other embodiments of the present disclosure.

### DETAILED DESCRIPTION

Exemplary embodiments of the disclosure will be described in detail with reference to the accompanying drawings. The following description is made only by way of example, but does not limit the present disclosure. Various embodiments of the present disclosure and various features in the embodiments that do not conflict with each other can be combined and rearranged in various ways. Without departing from the spirit and scope of the present disclosure, modifications, equivalents, or improvements to the present disclosure are conceivable to those skilled in the art and are intended to be encompassed within the scope of the present disclosure.

In accordance with various embodiments, the present disclosure provides an information processing method, and a related storage device.

In the following, a first implementation of the present disclosure is described in accordance with some embodiments.

FIG. 1 illustrates a schematic flow diagram of an exemplary method for information processing in accordance with some embodiments of the present disclosure. The method can include the following processes.

At S110, a first operating system is installed on an electronic device.

At S120, a storage path of a boot code of the first operating system and a system name of the first operating system are obtained.

At S130, a boot variable is generated based on the storage path and the system name. In some embodiments, the boot variable is generated based on the boot code retrieved using the storage path and system name of the first operating system.

At S140, both of the boot variable and the boot code are stored in a first storage medium of the electronic device. The first storage medium may be a removable or non-removable medium.

The disclosed method for information processing may be applied to various electronic apparatuses such as desktop computers, notebook computers, tablet PCs, or servers, etc.

The first operating system installed at S110 may be any suitable type of operating system, such as a Windows system, another operation system that is compatible with the Unified Extensible Firmware Interface (UEFI), or the like. After installing the first operating system, the operation code of the first operating system may be stored on the first storage medium. The first storage medium may be a removable or non-removable medium.

The boot code may also be referred to as a bootstrap program, which is used for booting the first operating system.

In some embodiments, the boot variable may be stored at any suitable location on the first storage medium. For example, the boot variable may be stored in the reserved bytes for protective master boot record (PMBR) in the first sector of the first storage medium.

In some embodiments, the first storage medium may be a storage medium in the form of Globally Unique Identifier (GUID) Partition Table (GPT). The first storage medium may be a removable storage medium. The boot variable may be stored in the reserved bytes for PMBR on the first storage medium in the GPT format. As such, not only can the boot variable be stored, the compatibility with the existing technologies can be improved to avoid affecting the storage of other information on the first storage medium.

FIG. 4 illustrates a schematic diagram of a partition of an exemplary storage medium in accordance with some embodiments of the present disclosure. As shown, the first storage medium includes a primary partition table, a backup partition table, and other partitions.

The primary partition table may store PMBR and a Partition Table Header (PTH). The backup partition table may store a PTH for backup.

The primary partition table may include a partition header and a partition entry (PE) for each partition. The n-th partition entry can be at least used to indicate a start position and an end position of the n-th partition.

As shown in FIG. 4, LBA is an abbreviation for logical block address. LBA0 denotes a logical block address 0, LBA1 denotes a logical block address 1, and LBAn denotes a logical block address n. Each logical block address may correspond to one logical block.

Table 1 may represent a definition of the PMBR of the first storage medium having the GPT format described above.

TABLE 1

| | Byte | Byte | |
|---|---|---|---|
| Mnemonic | Offset | Length | Description |
| Boot Code | 0 | 440 | Code used on a legacy system to select |
| | | | a partition record and load the first block |
| | | | (sector) of the partition pointed to by the |
| | | | partition record. This code may not be |
| | | | executed on UEFI systems. |
| Unique | 440 | 4 | Unique Disk Signature, this may be |
| MBR | | | an optional feature and not on all hard |
| Signature | | | drives. This value is always written by the |
| | | | OS and is never written by EFI firmware. |
| Unknown | 444 | 2 | Unknown |
| Partition | 446 | 16 * 4 | Array of four legacy BMR |
| Record | | | partition records |
| Signature | 510 | 2 | Must be 0xaa55 (i.e., byte 510 contains |
| | | | 0x55, and byte 511 contains 0xaa). |
| Reserved | 512 | Block | The rest of the logical block, if any, |
| | | Size - | is reserved. |
| | | 512 | |

In some embodiments, according to the storage location of the boot program, the storage path and the system name of the boot code of the first operating system may be automatically generated by an electronic apparatus by executing predetermined program codes, thus having a low error rate.

The boot variable can be generated at S130 based on the storage path and the system name information.

In some existing methods, the boot code is usually stored on a hard disk and the boot program is stored in the Basic Input/Output System (“BIOS”). As such, when the BIOS executes the boot code, according to the boot variable stored in the BIOS, the boot code can be read from the corresponding storage location in the hard disk to complete the boot process of the operating system startup.

However, in some embodiments of the present disclosure, the boot variable and the boot code can be stored in a same storage medium, which is referred to as the first storage medium. The first storage medium may be a removable storage medium. As such, when the first storage medium is moved from one electronic apparatus to another electronic apparatus, the other electronic apparatus may still be able to obtain the storage location of the boot code based on the boot variable on the first storage medium. Further, system name of the first operating system located on the first storage medium may also be accurately obtained based on the boot variable.

Therefore, when the boot variable and the boot code are stored in a same storage medium, the problem of loss or error of the boot variable caused by the transfer of the storage medium in the existing methods can be resolved.

Further, in some embodiments, in order to avoid the adverse effect to the existing information stored on the first storage medium, the boot variable can be stored in the reserved byte of PMBR in the first sector. Thus, technology compatibility can be improved.

In the following, a second implementation of the present disclosure is described in accordance with some embodiments.

FIG. 1 illustrates a schematic flow diagram of an exemplary method for information processing in accordance with some embodiments of the present disclosure. The method can include the following processes.

At S110, a first operating system is installed on an electronic device.

At S120, a storage path of a boot code of the first operating system and a system name of the first operating system are obtained.

At S130, a boot variable is generated based on the storage path and the system name. In some embodiments, the boot variable is generated based on the boot code retrieved using the storage path and system name of the first operating system.

At S140, both of the boot variable and the boot code are stored in a first storage medium of the electronic device. The first storage medium may be a removable or non-removable medium.

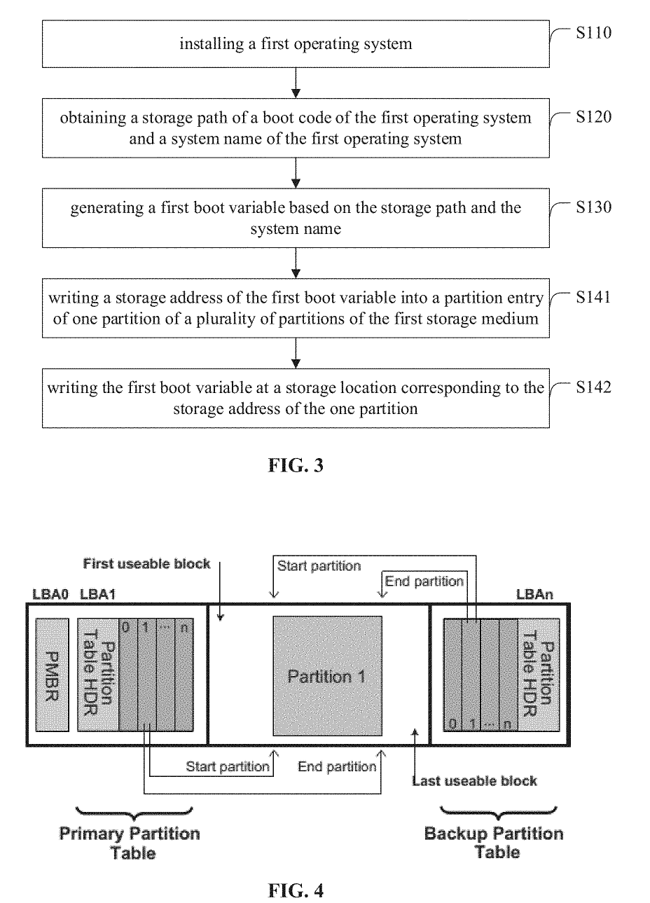

FIG. 3 illustrates a schematic flow diagram of another exemplary method for information processing in accordance with some other embodiments of the present disclosure. In some embodiments, S140 shown in FIG. 1 includes the following processes.

At S141, the storage address of the boot variable is written into the partition entry of the n-th partition of the first storage medium.

At S142, according to the storage address of the boot variable, the boot variable is written into the corresponding storage location of the n-th partition.

In some embodiments, the first storage medium may be divided into N partitions. Each of the partitions may correspond to a partition entry. Each partition entry is a special storage area on the first storage medium for indicating a corresponding partition. N may be a positive integer no less than n.

In some embodiments, the storage address of the boot variable may be written in the partition entry of the n-th partition, so that the electronic apparatus may, after scanning the first storage medium, scan and parse the partition entry to determine in which partition the boot variable is stored.

In some embodiments, in order to facilitate the electronic apparatus to read information, when the boot variable is stored in the n-th partition, the storage address of the boot variable may be written in the partition entry of the n-th partition. As such, when the electronic apparatus scans the storage address of the boot variable in the n-th partition, the electronic apparatus may read the boot variable from the corresponding position in the n-th partition based on the storage address.

By using a partition to store the boot variable and storing the storage address of the boot variable in the partition entry, embodiments of the present disclosure may achieve high level of simplicity and compatibility with existing techniques.

FIG. 4 illustrates a schematic diagram of a partition of an exemplary storage medium in accordance with some embodiments of the present disclosure. As shown, the first storage medium in the GPT format includes a primary partition table, a backup partition table, and other partitions.

The primary partition table may store PMBR and a Partition Table Header (PTH). The backup partition table may store a PTH for backup.

The primary partition table may include a partition header and a partition entry for each partition. The n-th partition entry can be at least used to indicate a start position and an end position of the n-th partition.

As shown in FIG. 4, LBA is an abbreviation for logical block address. LBA0 denotes a logical block address 0, LBA1 denotes a logical block address 1, and LBAn denotes a logical block address n. Each logical block address may correspond to one logical block.

Table 2 may represent a description of a partition entry.

TABLE 2

| | Byte | Byte | |
|---|---|---|---|
| Mnemonic | Offset | Length | Description |
| Partition | 0 | 16 | Unique ID that defines the purpose and |
| Type | | | type of this Partition. A value of |
| GUID | | | zero defines that this partition entry is |
| | | | not being used. |
| Unique | 16 | 16 | GUID is unique for each partition entry. |
| Partition | | | A partition ever created has a unique |
| GUID | | | GUID. This GUID is assigned when the |
| | | | GUID Partition Entry is created. The |
| | | | GUID Partition Entry is created |
| | | | whenever the Number Of Partition |
| | | | Entries in the GUID Partition Table |
| | | | Header is increased to include |
| | | | a larger range of addresses. |
| Starting | 32 | 8 | Starting LBA of the partition defined by |
| LBA | | | this entry. |
| Ending | 40 | 8 | Ending LBA of the partition defined by |
| LBA | | | this entry. |
| Attributes | 48 | 8 | Attribute bits, all bits reserved by UEFI. |
| Partition | 56 | 72 | Null-terminated name of the partition. |
| Name | | | |
| Reserved | 128 | Size Of | The rest of the GUID partition entry, |
| | | Partition | if any, is reserved by UEFI and |
| | | Entry - 72 | may be zero. |

In the following, a third implementation of the present disclosure is described in accordance with some embodiments.

FIG. 1 illustrates a schematic flow diagram of an exemplary method for information processing in accordance with some embodiments of the present disclosure. The method can include the following processes.

At S110, a first operating system is installed on an electronic device.

At S120, a storage path of a boot code of the first operating system and a system name of the first operating system are obtained.

At S130, a boot variable is generated based on the storage path and the system name.

At S140, both of the boot variable and the boot code are stored in a first storage medium of the electronic device. The first storage medium may be a removable or non-removable medium.

FIG. 3 illustrates a schematic flow diagram of another exemplary method for information processing in accordance with some other embodiments of the present disclosure. In some embodiments, S140 shown in FIG. 1 includes the following processes.

At S141, the storage address of the boot variable is written into the partition entry of the n-th partition of the first storage medium.

At S142, according to the storage address of the boot variable, the boot variable is written into the corresponding storage location of the n-th partition.

In some embodiments, S141 may include writing the sector indication information stored by the boot variable into the partition entry of the n-th partition.

Each partition may include a plurality of sectors. In some embodiments, the storage address written into the partition entry (PE) may be sector indication information indicating a sector identification of the storage sector. As such, when the electronic apparatus needs to read the boot variable, the electronic apparatus may scan the corresponding sector of the n-th partition to obtain the boot variable.

In some embodiments, S142 may include writing the boot variable in a sector of the n-th partition corresponding to the sector indication information.

Generally, the boot variable may be stored in any sector of the n-th partition. In some embodiments, in order to facilitate the information reading of the electronic apparatus, the sector storing the boot variable may be the first sector or the last sector of the n-th partition.

As such, the electronic apparatus can directly locate the first sector according to the starting position of the n-th partition in the partition entry field, or locate the last sector according to the ending position of the n-th partition in the partition entry field. Therefore, the boot variable may be easily read, and the reading efficiency can be improved.

In the following, a fourth implementation of the present disclosure is described in accordance with some embodiments.

FIG. 1 illustrates a schematic flow diagram of an exemplary method for information processing in accordance with some embodiments of the present disclosure. The method can include the following processes.

At S110, a first operating system is installed on an electronic device.

At S120, a storage path of a boot code of the first operating system and a system name of the first operating system are obtained.

At S130, a boot variable is generated based on the storage path and the system name. In some embodiments, the boot variable is generated based on the boot code retrieved using the storage path and system name of the first operating system.

At S140, both of the boot variable and the boot code are stored in a first storage medium of the electronic device. The first storage medium may be a removable or non-removable medium.

FIG. 3 illustrates a schematic flow diagram of another exemplary method for information processing in accordance with some other embodiments of the present disclosure. In some embodiments, S140 shown in FIG. 1 includes the following processes.

At S141, the storage address of the boot variable is written into the partition entry of the n-th partition of the first storage medium.

At S142, according to the storage address of the boot variable, the boot variable is written into the corresponding storage location of the n-th partition.

In some embodiments, S141 may include writing the sector indication information stored by the boot variable into the partition entry of the n-th partition. For example, the sector indication information may be written in the attribute bytes of the partition entry of the n-th partition.

In some embodiments, S142 may include writing the boot variable in a sector of the n-th partition corresponding to the sector indication information.

The partition entry in the n-th partition may contain a plurality of attribute bytes. In some existing techniques, the attribute bytes may be reserved bytes, and do not have defined content. In some embodiments, the sector indication information of the boot variable may be written in the attribute bytes. Thus, the disclosed method may be compatible well with the existing techniques to avoid affecting the other content distributed in the existing partition. Therefore, the disclosed method for information processing can have a strong compatibility.

Table 3 shows the description of the plurality of attribute bytes.

TABLE 3

| Bits | Description |
|---|---|
| Bit 0 | If this bit is set, the partition is required for the platform to |
| | function. The owner/creator of the partition indicates that deletion |
| | or modification of the contents can result in loss of platform |
| | features or failure of the platform to boot or operate. The system |
| | may not function normally if this partition is removed. In addition, |
| | it may be considered part of the hardware of the system. Actions |
| | such as running diagnostics, system recovery, or OS install or |
| | boot may potentially stop working if this partition is removed. |
| | Unless OS software of firmware recognizes this partition, it may |
| | never be removed or modified as the UEFI firmware or platform |
| | hardware may become non-functional. |
| Bit 1 | If this bit is set the firmware may not produce an EFI BLOCK IO |
| | PROTOCAL device for this partition. By not producing the |
| | EFI BLOCK IO PROTOCAL partition, file system mappings |
| | may not be created for this partition in UEFI. |
| Bits | Undefined and may be zero. Reserved for expansion by future |
| 2-47 | versions of the UEFI specification. |
| Bits | Reserved for GUID specific use. The use of these bits may vary |
| 48-63 | depending on the Partition Type GUID. The owner of the Partition |
| | Type GUID is allowed to modify these bits. They may be |
| | preserved if Bits 0-47 are modified. |

In some embodiments, one or more bits of Bits 2-47 may be used to record the storage address of the boot variable. For example, in some embodiment, the attribute bytes may be modified as shown in Table 4.

TABLE 4

| Bits | Description |
|---|---|
| Bit 0 | If this bit is set, the partition is required for the platform to |
| | function. The owner/creator of the partition indicates that deletion |
| | or modification of the contents can result in loss of platform |
| | features or failure of the platform to boot or operate. The system |
| | may not function normally if this partition is removed. Inaddition, |
| | it may be considered part of the hardware of the system. Actions |
| | such as running diagnostics, system recovery, or OS install or |
| | boot may potentially stop working if this partition is removed. |
| | Unless OS software of firmware recognizes this partition, it |
| | may never be removed or modified as the UEFI firmware or |
| | platform hardware may become non-functional. |
| Bit 1 | If this bit is set the firmware may not produce an EFI BLOCK IO |
| | PROTOCAL device for this partition. By not producing the |
| | EFI BLOCK IO PROTOCAL partition, file system mappings |
| | may not be created for this partition in UEFI. |
| Bit 2 | Used for indicating the storage address of the boot variable. |
| Bits | Undefined and may be zero. Reserved for expansion by |
| 3-47 | future versions of the UEFI specification. |
| Bits | Reserved for GUID specific use. The use of these bits may vary |
| 48-63 | depending on the Partition Type GUID. The owner of the |
| | Partition Type GUID is allowed to modify these bits. They may be |
| | preserved if Bits 0-47 are modified. |

Specifically, the definitions of the attribute bytes Bits 2-10 can be shown in Table 5.

TABLE 5

| Bits | Description |
|---|---|
| Bit 2 | Starting LBA or ending LBA used for UEFI OS variable |

If the contents of the attribute bytes Bits 2-10 are as shown in Table 5, it indicates that the storage address of the boot variable is stored at the starting LBA of the n-th partition or the ending LBA of the n-th partition.

In the following, a fifth implementation of the present disclosure is described in accordance with some embodiments.

FIG. 1 illustrates a schematic flow diagram of an exemplary method for information processing in accordance with some embodiments of the present disclosure. The method can include the following processes.

At S110, a first operating system is installed on an electronic device.

At S120, a storage path of a boot code of the first operating system and a system name of the first operating system are obtained.

At S130, a boot variable is generated based on the storage path and the system name.

At S140, both of the boot variable and the boot code are stored in a first storage medium of the electronic device. The first storage medium may be a removable or non-removable medium.

FIG. 3 illustrates a schematic flow diagram of another exemplary method for information processing in accordance with some other embodiments of the present disclosure. In some embodiments, S140 shown in FIG. 1 includes the following processes.

At S141, the storage address of the boot variable is written into the partition entry of the n-th partition of the first storage medium.

At S142, according to the storage address of the boot variable, the boot variable is written into the corresponding storage location of the n-th partition.

In some embodiments, a boot entry can be provided in the n-th partition. The boot entry can be in the same partition in which the boot variable is written. The boot entry can include storage path bytes and system name bytes.

In some embodiments, S142 may include storing the storage path in the storage path bytes, and storing the system name in the system name bytes.

That is, the boot entry at least includes storage path bytes for storing the storage path, and system name bytes for storing the system name. As such, the electronic apparatus can read the system name and the storage path from the corresponding bytes when reading the boot variable. Therefore, the disclosed method can be convenient for reading the system name and the boot code based on the storage path.

In some embodiments, at S140, the boot variable may also be stored in the reserved bytes in the first sector of the first storage medium for storing the protected boot records.

The protected boot records may include the boot entry. The boot entry may include storage path bytes, system name bytes, and storage partition bytes.

In some embodiments, S140 may include storing the storage path in the storage path bytes, storing the system name in the system name bytes, and storing a partition identifier of the partition in which the boot code is located in the storage partition bytes.

In some embodiments, in order to facilitate the reading of the boot variable by the electronic apparatus, a boot entry can be specifically provided. Further, in order to accurately and easily read the boot variable, the boot entry at least includes storage path bytes for storing the storage path of the boot variable, and system name bytes for storing the system name of the first operating system.

A plurality of partitions may be stored on the first storage medium. The boot variable may be stored in any suitable one of the partitions. In some embodiments, in order to facilitate the reading of the boot variable by the electronic apparatus, storage partition bytes can be provided for storing the partition identifier of the partition where the boot code is located. As such, in conjunction with the boot variable and the partition identifier, the electronic apparatus can read the boot code from the corresponding partition. Therefore, the disclosed method provides a desirable convenience for storing the boot variable.

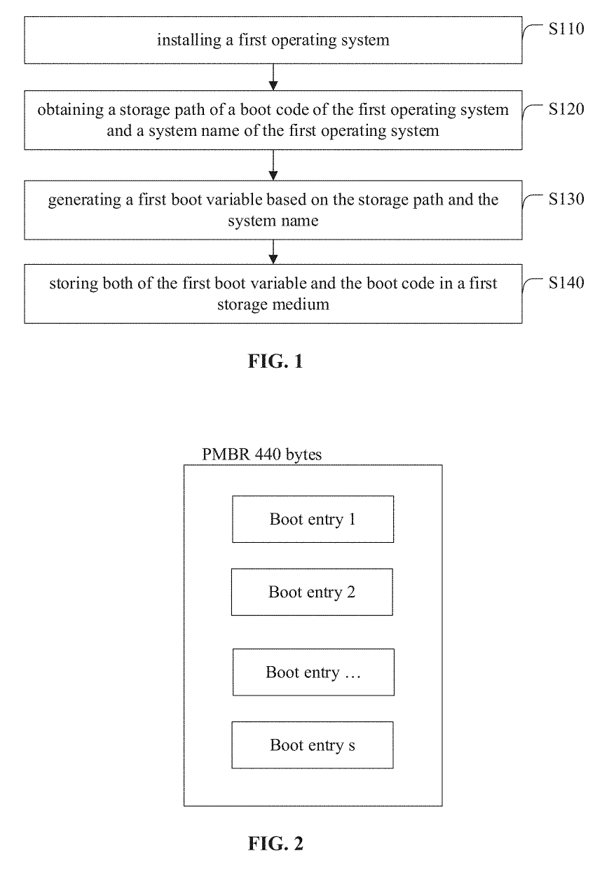

FIG. 2 illustrates a schematic diagram of an exemplary Protective Master Boot Record (PMBR) in accordance with some embodiments of the present disclosure.

In some embodiments, the reserved bytes of the PMBR may include 440 bytes. When multiple operation codes and boot codes of a plurality of operating systems are stored on the first storage medium, the 440 bytes may be used for the storage of multiple boot variables of the multiple boot codes for the plurality of operating systems respectively.

As shown in FIG. 2, there are multiple boot variables stored in 440 bytes, which can include boot entry 1, boot entry 2 . . . and boot entry S, etc.

In the following, a sixth implementation of the present disclosure is described in accordance with some embodiments.

FIG. 1 illustrates a schematic flow diagram of an exemplary method for information processing in accordance with some embodiments of the present disclosure. The method can include the following processes.

At S110, a first operating system is installed on an electronic device.

At S120, a storage path of a boot code of the first operating system and a system name of the first operating system are obtained.

At S130, a boot variable is generated based on the storage path and the system name. In some embodiments, the boot variable is generated based on the boot code retrieved using the storage path and system name of the first operating system.

At S140, both of the boot variable and the boot code are stored in a first storage medium of the electronic device. The first storage medium may be a removable or non-removable medium.

FIG. 3 illustrates a schematic flow diagram of another exemplary method for information processing in accordance with some other embodiments of the present disclosure. In some embodiments, S140 shown in FIG. 1 includes the following processes.

At S141, the storage address of the boot variable is written into the partition entry of the n-th partition of the first storage medium.

At S142, according to the storage address of the boot variable, the boot variable is written into the corresponding storage location of the n-th partition.

In some embodiments, a boot entry can be provided in the n-th partition. The boot entry can include storage path bytes and system name bytes.

In some embodiments, S142 may include storing the storage path in the storage path bytes, and storing the system name in the system name bytes.

The boot entry can further include storage path length bytes and system name length bytes.

In some embodiments, at S140, the boot variable may also be stored in the reserved bytes in the first sector of the first storage medium for storing the protected boot records.

The protected boot records may include the boot entry. The boot entry may include storage path bytes, system name bytes, and storage partition bytes.

In some embodiments, S140 may include storing the storage path in the storage path bytes, storing the system name in the system name bytes, and storing a partition identifier of the partition in which the boot code is located in the storage partition bytes.

The boot entry can further include storage path length bytes and system name length bytes.

The method can further include storing a required number of bytes for the storage path in the storage path length bytes, and storing a required number of bytes for the system name in the system name length bytes.

In order to facilitate the subsequent reading operation of the electronic apparatus, in some embodiment, the storage path length bytes and the system name length bytes can also be included in the boot entry of the operating system for storing a required number of bytes for the storage path and storing a required number of bytes for the system name in the boot variable. As such, the electronic apparatus can subsequently determine the number of bytes occupied by the storage address and the system name based on reading the storage path length bytes and the system name length bytes. Thus, the reading operation of the electronic apparatus can be simplified.

In the following, a seventh implementation of the present disclosure is described in accordance with some embodiments.

FIG. 1 illustrates a schematic flow diagram of an exemplary method for information processing in accordance with some embodiments of the present disclosure. The method can include the following processes.

At S110, a first operating system is installed on an electronic device.

At S120, a storage path of a boot code of the first operating system and a system name of the first operating system are obtained.

At S130, a boot variable is generated based on the storage path and the system name. In some embodiments, the boot variable is generated based on the boot code retrieved using the storage path and system name of the first operating system.

At S140, both of the boot variable and the boot code are stored in a first storage medium of the electronic device. The first storage medium may be a removable or non-removable medium.

FIG. 3 illustrates a schematic flow diagram of another exemplary method for information processing in accordance with some other embodiments of the present disclosure. In some embodiments, S140 shown in FIG. 1 includes the following processes.

At S141, the storage address of the boot variable is written into the partition entry of the n-th partition of the first storage medium.

At S142, according to the storage address of the boot variable, the boot variable is written into the corresponding storage location of the n-th partition.

In some embodiments, a boot entry can be provided in the n-th partition. The boot entry can include storage path bytes and system name bytes.

In some embodiments, S142 may include storing the storage path in the storage path bytes, and storing the system name in the system name bytes.

In some embodiments, at S140, the boot variable may also be stored in the reserved bytes in the first sector of the first storage medium for storing the protected boot records.

The protected boot records may include the boot entry. The boot entry may include storage path bytes, system name bytes, and storage partition bytes.

In some embodiments, S140 may include storing the storage path in the storage path bytes, storing the system name in the system name bytes, and storing a partition identifier of the partition in which the boot code is located in the storage partition bytes.

The boot entry can further include storage path length bytes and system name length bytes.

The method can further include storing a required number of bytes for the storage path in the storage path length bytes, and storing a required number of bytes for the system name in the system name length bytes.

In some embodiments, the boot entry may include start identification bytes and check bytes.

The method can further includes storing a start identifier in the start identification bytes, and storing a check code for the data stored in the boot entry in the check bytes.

In some embodiments, the start identifier is stored by the start identification bytes, so that it is convenient for the electronic apparatus to easily determine that it is started to read the boot variable by scanning or reading the start identifier.

In addition, in order to ensure the correctness of the information, check bytes are introduced in some embodiments. The check code can be stored in the check bytes. The check code can be used to verify other information in the boot entry. If the verification is correct, it can be determined that the boot variable stored in the current boot entry is correct. Otherwise, it can be determined that the boot variable stored in the current boot entry is wrong. As such, illegal tampering can be prevented, and the storage reliability of the boot variable can be enhanced.

Table 6 represents a definition of an example boot entry.

TABLE 6

| Mnemonic | Byte Length | Description |
|---|---|---|
| Start identification bytes | 1 | 0x02 (ASCII STX), a |
| | | starting position |
| Storage path length bytes | 1 | Example: 28 |
| Storage path bytes | defined by | Example: boot/efi/ |
| | the size | redhat/EFI/grub.efi |
| | of the | |
| | boot code | |
| System name length bytes | 1 | Example: 27 |
| System name bytes | defined by | Example: RedHat |
| | the size | Enterprise Linux 7.2 |
| | of the | |
| | system | |
| | name | |
| CRC16 | 2 | Checksum |

In the following, an eighth implementation of the present disclosure is described in accordance with some embodiments.

FIG. 1 illustrates a schematic flow diagram of an exemplary method for information processing in accordance with some embodiments of the present disclosure. The method can include the following processes.

At S110, a first operating system is installed on an electronic device.

At S120, a storage path of a boot code of the first operating system and a system name of the first operating system are obtained.

At S130, a boot variable is generated based on the storage path and the system name. In some embodiments, the boot variable is generated based on the boot code retrieved using the storage path and system name of the first operating system.

At S140, both of the boot variable and the boot code are stored in a first storage medium of the electronic device. The first storage medium may be a removable or non-removable medium.

In some embodiment, at S140, the boot variable may be stored in the reserved bytes in the first sector of the first storage medium for storing the protected boot records.

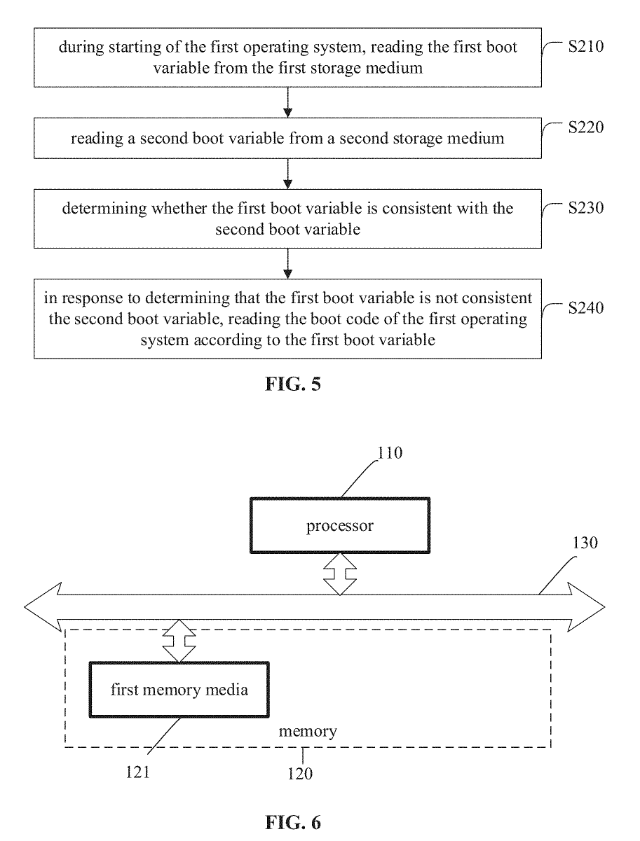

FIG. 5 illustrates a schematic flow diagram of another exemplary method for information processing in accordance with some other embodiments of the present disclosure. The method can further include the following processes.

At S210, a first boot variable is read from the first storage medium when the first operating system is started.

At S220, a second boot variable is read from a second storage medium of the first operating system.

At S230, it is determined whether the first boot variable and the second boot variable are consistent.

At S240, in response to determining that the first boot variable and the second boot variable are not consistent, the boot code of the first operating system is read according to the first boot variable.

In some embodiments, when the first operating system is started, a second storage medium of the BIOS may store a second boot variable. In some embodiments, the boot variable stored on the first storage medium may be referred to as the first boot variable.

There may be a phenomenon of hard disk migration. When the first storage medium is moved from one electronic apparatus to another electronic apparatus, the first boot variable can be read from the first storage medium, and the second boot variable can be read from the second storage medium of the BIOS. The first boot variable can be compared with the second boot variable.

In some embodiments, the second storage medium is not the same storage medium as the first storage medium. The second storage medium does not store the first boot variable and the operation code of the first operating system.

In response to determining that the first boot variable and the second boot variable are not consistent, that is, the first boot variable is different from the second boot variable, the boot code of the first operating system can be read directly based on the first boot variable as a correct one. Therefore, the problems of improper-reading of the boot code and abnormal operation of the system cause by the hard disk migration can be resolved.

Noted that, this implementation is a further improvement on the basis of any of the preceding implementations. The specific storage location of the first boot variable on the first storage medium and the specific storage method can be referred to the second implementation to the seventh implementation, which is not repeated herein.

In the following, a ninth implementation of the present disclosure is described in accordance with some embodiments.

FIG. 1 illustrates a schematic flow diagram of an exemplary method for information processing in accordance with some embodiments of the present disclosure. The method can include the following processes.

At S110, a first operating system is installed on an electronic device.

At S120, a storage path of a boot code of the first operating system and a system name of the first operating system are obtained.

At S130, a boot variable is generated based on the storage path and the system name. In some embodiments, the boot variable is generated based on the boot code retrieved using the storage path and system name of the first operating system.

At S140, both of the boot variable and the boot code are stored in a first storage medium of the electronic device. The first storage medium may be a removable or non-removable medium.

In some embodiment, at S140, the boot variable may be stored in the reserved bytes in the first sector of the first storage medium for storing the protected boot records.

FIG. 5 illustrates a schematic flow diagram of another exemplary method for information processing in accordance with some embodiments of the present disclosure. The method can further include the following processes.

At S210, a first boot variable is read from the first storage medium when the first operating system is started.

At S220, a second boot variable is read from a second storage medium of the first operating system.

At S230, it is determined whether the first boot variable and the second boot variable are consistent.

At S240, in response to determining that the first boot variable and the second boot variable are not consistent, the boot code of the first operating system is read according to the first boot variable.

In some embodiments, at S240, in response to determining that the first boot variable and the second boot variable are not consistent, the second boot variable in the second storage medium is further replaced by the first boot variable, and the boot code of the first operating system is read according to the replaced second boot variable.

In some embodiments, the second boot variable in the second storage medium of the BIOS can be replaced with the first boot variable in some embodiments, it can be convenient for the BIOS to read the boot code at the present booting of the operating system, and also convenient for the BIOS to read the boot variable at the next booting of the operating system.

In the following, a tenth implementation of the present disclosure is described in accordance with some embodiments.

FIG. 1 illustrates a schematic flow diagram of an exemplary method for information processing in accordance with some embodiments of the present disclosure. The method can include the following processes.

At S110, a first operating system is installed on an electronic device.

At S120, a storage path of a boot code of the first operating system and a system name of the first operating system are obtained.

At S130, a boot variable is generated based on the storage path and the system name. In some embodiments, the boot variable is generated based on the boot code retrieved using the storage path and system name of the first operating system.

At S140, both of the boot variable and the boot code are stored in a first storage medium of the electronic device. The first storage medium may be a removable or non-removable medium.

In some embodiment, at S140, the boot variable may be stored in the reserved bytes in the first sector of the first storage medium for storing the protected boot records.

FIG. 5 illustrates a schematic flow diagram of another exemplary method for information processing in accordance with some other embodiments of the present disclosure. The method can further include the following processes.

At S210, a first boot variable is read from the first storage medium when the first operating system is started.

At S220, a second boot variable is read from a second storage medium of the first operating system.

At S230, it is determined whether the first boot variable and the second boot variable are consistent.

At S240, in response to determining that the first boot variable and the second boot variable are not consistent, the boot code of the first operating system is read according to the first boot variable.

In some embodiments, the method may further include: in response to determining that the first boot variable and the second boot variable are consistent, the boot code of the first operating system is read according to the second boot variable.

When the first boot variable and the second boot variable are consistent, it can be determined that the second boot variable in the second storage medium of the BIOS is correct. Therefore, the boot code of the first operating system can be read directly based on the second boot variable.

In the following, an eleventh implementation of the present disclosure is described in accordance with some embodiments.

FIG. 6 illustrates a schematic structural diagram of an exemplary electronic apparatus in accordance with some embodiments of the present disclosure.

As shown, the electronic apparatus includes a processor 110 and at least one memory 120 detachably connected to the processor 110. The memory includes at least a first storage medium 121 detachably connected to the processor 110.

The processor 110 can be configured for installing a first operating system, obtaining a storage path of the boot code of the first operating system and a system name of the first operating system, and generating a boot variable based on the system name and the storage path.

The processor 110 can be further configured for storing the boot variable and the boot code stored in a same storage media. In some embodiments, both the boot variable and the boot code may be stored on the first storage media 121. The first storage media 121 may be a removable or non-removable storage media.

In some embodiments, the processor 110 is configured for storing the boot variable in reserved bytes in a first sector of the first storage media 121 for storing protected boot records. The first storage media 121 may be a removable or non-removable storage media.

In some embodiments, the processor 110 may be one or more of any suitable processing chips or processing circuits, such as a central processing unit (CPU), a microprocessor (MCU), a digital signal processor (DSP), an application processor (AP), a programmable array (PLC), a dedicated Integrated circuit (ASIC), etc.

In some embodiments, the processor 110 may perform the operations including the installation of the first operating system, the generation of the boot variable, and the like by executing the predetermined codes.

The memory 120 may be one or more of any suitable memories for various storage media. In some embodiments, the memory 120 may be a non-transient storage media, such as a flash memory.

The processor 110 and the memory 120 may be detachably connected. As such, when the memory 220 is disconnected from the processor 110 and connected to another processor, all of the operation codes of the first operating system, the boot code, and the boot variable can be still stored in the same memory 220.

Therefore, it can facilitate the determination of the storage location of the boot code and the system name of the first operating system directly based on the boot variable stored in the memory. The problems of improper-retrieving of the boot code and abnormal booting of the first operating system cause by memory migration in some existing methods can be resolved.

Further, as shown in FIG. 6, a bus 130 is provided for connecting the processor 110 and the memory 120. The bus here can be any suitable type of bus that can carry out data transfers. For example, the bus 130 can be a Peripheral Component Interconnect (PCI) bus or an Inter-IC Sound (IIS) bus. The memory 120 may be connected to the processor 110 via a detachable interface on the bus 130 such as a PCI bus or an IIS bus.

In the following, a twelfth implementation of the present disclosure is described in accordance with some embodiments.

FIG. 6 illustrates a schematic structural diagram of an exemplary electronic apparatus in accordance with some embodiments of the present disclosure.

As shown, the electronic apparatus includes a processor 110 and at least one memory 120 detachably connected to the processor 110. The memory includes at least a first storage media 121 detachably connected to the processor 110.

The processor 110 can be configured for installing a first operating system, obtaining a storage path of the boot code of the first operating system and a system name of the first operating system, and generating a boot variable based on the system name and the storage path.

The processor 110 can be further configured for storing the boot variable and the boot code stored in a same storage media. In some embodiments, both of the boot variable and the boot code stored on the first storage media 121. The first storage media 121 may be a removable or non-removable storage media.

The first storage media 121 can include a plurality of partitions. A number of the plurality of partitions can be represented by N, which is an integer no less than 1.

The processor 110 can be further configured for writing the storage address of the boot variable into the partition entry of the n-th partition of the first storage medium, and writing the boot variable into the corresponding storage address in the n-th partition, where n may be a positive integer no larger than N.

In some embodiments, the processor 110 can divide the first storage medium into N partitions. The processor 110 can store the boot code in the n-th partition, and store the boot variable in the partition entry of the n-th partition. A description of the partition entry is provided in the corresponding method embodiments described above.

Therefore, in some embodiments, the boot code and the boot variable can be stored in a same partition of the first storage medium 121, thereby facilitating the subsequent reading operations of the processor 110.

In the following, a thirteenth implementation of the present disclosure is described in accordance with some embodiments.

FIG. 6 illustrates a schematic structural diagram of an exemplary electronic apparatus in accordance with some embodiments of the present disclosure.

As shown, the electronic apparatus includes a processor 110 and at least one memory 120 detachably connected to the processor 110. The memory includes at least a first storage medium 121 detachably connected to the processor 110.

The processor 110 can be configured for installing a first operating system, obtaining a storage path of the boot code of the first operating system and a system name of the first operating system, and generating a boot variable based on the system name and the storage path.

The processor 110 can be further configured for storing the boot variable and the boot code stored in a same storage media. In some embodiments, both of the boot variable and the boot code stored on the first storage media 121. The first storage media 121 may be a removable or non-removable storage media.

The first storage media 121 can include a plurality of partitions. A number of the plurality of partitions can be represented by N, which is an integer no less than 1.

The processor 110 can be further configured for writing the storage address of the boot variable into the partition entry of the n-th partition of the first storage medium, and writing the boot variable into the corresponding storage address in the n-th partition, where n may be a positive integer no larger than N.

The first storage medium 121 may further store a partition table.

A description of the partition table is provided in the corresponding method embodiments described above.

The processor 110 can be specifically configured for writing sector indication information of the boot variable into the partition entry of the n-th partition in the partition table of the first storage medium 121, and writing the boot variable into a sector in the n-th partition indicated by the sector indication information.

In some embodiments, the processor 110 can write the sector indication information in to the partition entry of the n-th partition of the first storage medium 121. The sector indicated by the sector indication information may be generally used only for storing the boot variables. As such, the processor 110 can subsequently read the boot code directly from the sector based on the boot variable read from the sector, thereby simplifying the implementation.

In the following, a fourteenth implementation of the present disclosure is described in accordance with some embodiments.

FIG. 6 illustrates a schematic structural diagram of an exemplary electronic apparatus in accordance with some embodiments of the present disclosure.

As shown, the electronic apparatus includes a processor 110 and at least one memory 120 detachably connected to the processor 110. The memory includes at least a first storage medium 121 detachably connected to the processor 110.

The processor 110 can be configured for installing a first operating system, obtaining a storage path of the boot code of the first operating system and a system name of the first operating system, and generating a boot variable based on the system name and the storage path.

The processor 110 can be further configured for storing the boot variable and the boot code stored in a same storage media. In some embodiments, both of the boot variable and the boot code stored on the first storage media 121. The first storage media 121 may be a removable or non-removable storage media.

The first storage media 121 can include a plurality of partitions. A number of the plurality of partitions can be represented by N, which is an integer no less than 1.

The processor 110 can be further configured for writing the storage address of the boot variable into the partition entry of the n-th partition of the first storage medium, and writing the boot variable into the corresponding storage address in the n-th partition, where n may be a positive integer no larger than N.

The first storage medium 121 may further store a partition table.

A description of the partition table can be referred to the corresponding method embodiments described above.

The processor 110 can be specifically configured for writing sector indication information of the boot variable into the partition entry of the n-th partition in the partition table of the first storage medium 121, and writing the boot variable into a sector in the n-th partition indicated by the sector indication information.

The processor 110 can be further specifically configured for writing the sector indication information into attribute bytes of the partition entry of the n-th partition of the first storage medium.

In some specific implementations, the processor 110 may write the sector indication information into the attribute bytes of the partition entry. The attribute bytes can be reserved bytes, which may be generally reserved for the UEFI system.

The sector indication information is stored in the reserved attribute bytes, which can be compatible with existing technologies.

In the following, a fifteenth implementation of the present disclosure is described in accordance with some embodiments.

FIG. 6 illustrates a schematic structural diagram of an exemplary electronic apparatus in accordance with some embodiments of the present disclosure.

As shown, the electronic apparatus includes a processor 110 and at least one memory 120 detachably connected to the processor 110. The memory includes at least a first storage medium 121 detachably connected to the processor 110.

The processor 110 can be configured for installing a first operating system, obtaining a storage path of the boot code of the first operating system and a system name of the first operating system, and generating a boot variable based on the system name and the storage path.

The processor 110 can be further configured for storing the boot variable and the boot code stored in a same storage media. In some embodiments, both of the boot variable and the boot code stored on the first storage media 121. The first storage media 121 may be a removable or non-removable storage media.

The first storage media 121 can include a plurality of partitions. A number of the plurality of partitions can be represented by N, which is an integer no less than 1.

The processor 110 can be further configured for writing the storage address of the boot variable into the partition entry of the n-th partition of the first storage medium, and writing the boot variable into the corresponding storage address in the n-th partition, where n may be a positive integer no larger than N.

The first storage medium 121 may further store a partition table.

A description of the partition table can be referred to the corresponding method embodiments described above.

The processor 110 can be specifically configured for writing sector indication information of the boot variable into the partition entry of the n-th partition in the partition table of the first storage medium 121, and writing the boot variable into a sector in the n-th partition indicated by the sector indication information.

The processor 110 can be further specifically configured for writing the sector indication information into attribute bytes of the partition entry of the n-th partition of the first storage medium.

A boot entry can be provided in the n-th partition. The boot entry can include storage path bytes and system name bytes.

The processor 110 can be further specifically configured for storing the storage path into the storage path bytes and storing the system name into the system name byte of the first storage medium 121. The first storage media 121 may be a removable or non-removable storage media.

In some embodiments, the boot entry includes at least storage path bytes for storing the storage path, and system name bytes for storing the system name, thereby causing convenience for the implementation.

In some embodiments, the processor 110 can be further configured for storing the boot variable in reserved bytes for storing a protected boot records in the first sector of the first storage medium 121 where the boot code is stored.

The protection boot records can include the boot entry. The boot entry can includes storage path bytes, system name bytes, and storage partition bytes.

The processor 110 can be further configured for storing the storage path into the storage path bytes of the first storage medium 121, storing the system name into the system name bytes, and sorting the partition identifier of the partition where the boot code is located into the storage partition bytes.

In some embodiments, the boot entry may be a new data entry added into the boot entry. In some embodiments, in order to facilitate the subsequent information reading of the electronic apparatus, the boot entry can be divided into at least storage path bytes, system name bytes, and storage partition bytes. As such, the electronic apparatus can directly identify the read information content based on which bytes the information content is read from, thereby simplifying the reading of the information.

In some embodiments, the boot entry can also include a partition identifier, which is a partition for storing the boot code. In some embodiments, the boot variable may also include the partition identifier. That is, the partition identifier may be a part of the boot variable, or may be a part excluded from the boot variable.

In the following, a sixteenth implementation of the present disclosure is described in accordance with some embodiments.

FIG. 6 illustrates a schematic structural diagram of an exemplary electronic apparatus in accordance with some embodiments of the present disclosure.

As shown, the electronic apparatus includes a processor 110 and at least one memory 120 detachably connected to the processor 110. The memory includes at least a first storage medium 121 detachably connected to the processor 110.

The processor 110 can be configured for installing a first operating system, obtaining a storage path of the boot code of the first operating system and a system name of the first operating system, and generating a boot variable based on the system name and the storage path.

The processor 110 can be further configured for storing the boot variable and the boot code stored in a same storage media. In some embodiments, both of the boot variable and the boot code stored on the first storage media 121. The first storage media 121 may be a removable or non-removable storage media.

The first storage media 121 can include a plurality of partitions. A number of the plurality of partitions can be represented by N, which is an integer no less than 1.

The processor 110 can be further configured for writing the storage address of the boot variable into the partition entry of the n-th partition of the first storage medium, and writing the boot variable into the corresponding storage address in the n-th partition, where n may be a positive integer no larger than N.

The first storage medium 121 may further store a partition table.

A description of the partition table can be referred to the corresponding method embodiments described above.

The processor 110 can be specifically configured for writing sector indication information of the boot variable into the partition entry of the n-th partition in the partition table of the first storage medium 121, and writing the boot variable into a sector in the n-th partition indicated by the sector indication information.

The processor 110 can be further specifically configured for writing the sector indication information into attribute bytes of the partition entry of the n-th partition of the first storage medium.

A boot entry can be provided in the n-th partition. The boot entry can include storage path bytes and system name bytes.

The processor 110 can be further specifically configured for storing the storage path into the storage path bytes and storing the system name into the system name byte of the first storage medium 121. The first storage media 121 may be a removable or non-removable storage media.

In some embodiments, the boot entry includes at least storage path bytes for storing the storage path, and system name bytes for storing the system name, thereby causing convenience for the implementation.

In some embodiments, the boot entry further includes storage path length bytes and system name length bytes.

In some embodiments, the processor 110 can be further configured for storing the boot variable in the reserved bytes for storing a protected boot records in the first sector of the first storage medium 121 where the boot code is stored, storing the storage path into the storage path bytes, storing the system name into the system name bytes, and sorting the partition identifier of the partition where the boot code is located into the storage partition bytes.

The protected boot records can include the boot entry, and the boot entry can include the storage path bytes, the system name bytes, the storage partition bytes, the storage path length bytes, and the system name length bytes.

The processor 110 can be further configured for storing a required number of bytes for the storage path in the storage path length bytes, and storing a required number of bytes for the system name in the system name length bytes. As such, the electronic apparatus can be facilitate to subsequently determine the number of bytes occupied by the storage address and the system name based on reading the storage path length bytes and the system name length bytes.

In some other embodiments, the boot entry may further include start identification bytes and check bytes.

The processor 110 can be further configured for storing a start identifier in the start identification bytes, and storing a check code for the data stored in the boot entry in the check bytes.

By introducing the start bytes and storing the check code in the check bytes, an embodiment not only facilitates the reading of the boot variable by the electronic apparatus, but also ensures the accuracy of the stored boot variable by using the check code for information verification.

In the following, a seventeenth implementation of the present disclosure is described in accordance with some embodiments.

FIG. 6 illustrates a schematic structural diagram of an exemplary electronic apparatus in accordance with some embodiments of the present disclosure.

As shown, the electronic apparatus includes a processor 110 and at least one memory 120 detachably connected to the processor 110. The memory includes at least a first storage medium 121 detachably connected to the processor 110.

The processor 110 can be configured for installing a first operating system, obtaining a storage path of the boot code of the first operating system and a system name of the first operating system, and generating a boot variable based on the system name and the storage path.

The processor 110 can be further configured for storing the boot variable and the boot code stored in a same storage media. In some embodiments, both the boot variable and the boot code may be stored on the first storage media 121. The first storage media 121 may be a removable or non-removable storage media.

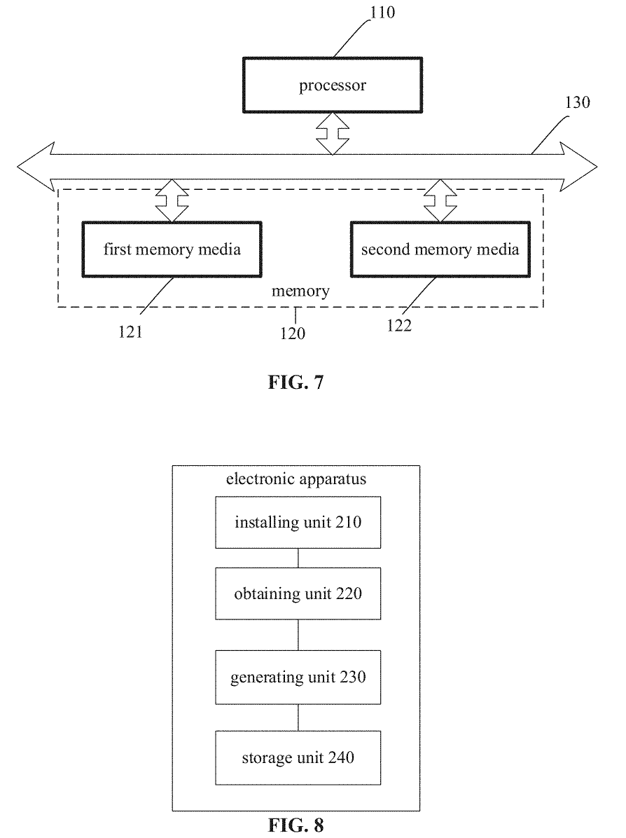

FIG. 7 illustrates a schematic structural diagram of another exemplary electronic apparatus in accordance with some other embodiments of the present disclosure.

As shown, the memory 120 may further include a second storage medium 122. The first storage medium 121 and the second storage medium 122 are different storage media. The second storage medium 122 may include a storage medium that is integrated with the BIOS in the electronic apparatus. The connection between the processor 110 and the second storage medium 122 may be a detachable connection or a non-removable connection.

The processor 110 can be further configured for reading a first boot variable from the first storage medium when the first operating system is started, reading a second boot variable from a second storage medium, determining whether the first boot variable and the second boot variable are consistent, and in response to determining that the first boot variable and the second boot variable are not consistent, reading the boot code of the first operating system according to the first boot variable.

In some embodiments, the boot code is read in accordance with the boot variable located in a same memory as the boot code. The processor 110 may execute a predetermined code to read the first boot variable and the second variable from the first storage medium and the second storage medium respectively. The first boot variable can be compared with the second boot variable.

In response to determining that the first boot variable and the second boot variable are not consistent, that is, the first boot variable is different from the second boot variable, the boot code of the first operating system can be read directly based on the first boot variable as a correct one. Therefore, the problems of improper-reading of the boot code and abnormal operation of the system cause by the hard disk migration can be resolved.

Further, the processor 110 can be further configured for, in response to determining that the first boot variable and the second boot variable are consistent, reading the boot code of the first operating system according to the second boot variable.

That is, when the first boot variable and the second boot variable are consistent, it can be determined that the second boot variable in the second storage medium is correct. Therefore, for high reading efficiency, the boot code of the first operating system can be read directly based on the second boot variable.

In the following, an eighteenth implementation of the present disclosure is described in accordance with some embodiments.

FIG. 6 illustrates a schematic structural diagram of an exemplary electronic apparatus in accordance with some embodiments of the present disclosure.

As shown, the electronic apparatus includes a processor 110 and at least one memory 120 detachably connected to the processor 110. The memory includes at least a first storage medium 121 detachably connected to the processor 110.

The processor 110 can be configured for installing a first operating system, obtaining a storage path of the boot code of the first operating system and a system name of the first operating system, and generating a boot variable based on the system name and the storage path.

The processor 110 can be further configured for storing the boot variable and the boot code stored in a same storage media. In some embodiments, both of the boot variable and the boot code stored on the first storage media 121. The first storage media 121 may be a removable or non-removable storage media.

FIG. 7 illustrates a schematic structural diagram of another exemplary electronic apparatus in accordance with some other embodiments of the present disclosure.

As shown, the memory 120 may further include a second storage medium 122. The first storage medium 121 and the second storage medium 122 are different storage media. The second storage medium 122 may include a storage medium that is integrated with the BIOS in the electronic apparatus. The connection between the processor 110 and the second storage medium 122 may be a detachable connection or a non-removable connection.

The processor 110 can be further configured for reading a first boot variable from the first storage medium when the first operating system is started, reading a second boot variable from a second storage medium, determining whether the first boot variable and the second boot variable are consistent, and in response to determining that the first boot variable and the second boot variable are not consistent, reading the boot code of the first operating system according to the first boot variable.

The processor 110 can be further configured for, in response to determining that the first boot variable and the second boot variable are not consistent, replacing the second boot variable in the second storage medium by the first boot variable, and reading the boot code of the first operating system according to the replaced second boot variable.

In some embodiments, when the first boot variable and the second boot variable are different, the processor 110 can replace the second boot variable in the second storage medium by the first boot variable. As such, it is convenient for the BIOS to read the boot variable quickly at the next booting of the operating system.

In the following, a nineteenth implementation of the present disclosure is described in accordance with some embodiments.

FIG. 8 illustrates a schematic structural diagram of an electronic apparatus in accordance with some other embodiments of the present disclosure.

As shown, the electronic apparatus includes an installing unit 210, an acquisition unit 220, a generating unit 230, and a storage unit 240.

The installing unit 210 can be configured for installing a first operating system.

The obtaining unit 220 can be configured for obtaining a storage path of the boot code of the first operating system and a system name of the first operating system.

The generating unit 230 can be configured for generating a boot variable based on the storage path and the system name.

The storage unit 240 can be configured for storing the boot variable and the boot code in a first storage medium.

In some embodiments, the electronic apparatus may be an apparatus corresponding to any of the above-described method embodiments. The installing unit 210, the obtaining unit 220, and the generating unit 230 may correspond to a processor or a processing circuit. The description of the processor or processing circuit may be referred to the method embodiments described above, and is not be repeated herein.

In some embodiments, the storage unit 240 may correspond to various memory chips for storing both of the boot variable and the boot code on the first storage medium. Therefore, the problems of improper-reading of the boot code and abnormal operation of the system cause by the hard disk migration can be solved.

In some embodiments, the storage unit 240 may be specifically configured for writing a storage address of the boot variable in a partition entry of the n-th partition of the first storage medium, and writing the boot variable in a storage location of the n-th partition corresponding to the storage address.

In some embodiments, the storage unit 240 may be specifically configured for writing sector indication information of the boot variable in the partitioned entry of the n-th partition, and writing the boot variable in a sector of the n-th partition corresponding to the sector indication information. For example, the storage unit 240 may be specifically configured for writing the sector indication information in attribute bytes of the partition entry of the n-th partition.

In some embodiments, the boot entry in the n-th partition can include storage path bytes and system name bytes. The storage unit 240 may be specifically configured for storing the storage path into the storage path bytes and storing the system name into the system name byte of the first storage medium.

In some embodiments, the boot entry may further include storage path length bytes and system name length bytes. The storage unit 240 may be specifically configured for storing a required number of bytes for the storage path in the storage path length bytes, and storing a required number of bytes for the system name in the system name length bytes.

In some other embodiments, the boot entry may further include start identification bytes and check bytes. The storage unit 240 may be specifically configured for storing a start identifier in the start identification bytes, and storing a check code for the data stored in the boot entry in the check bytes.

In some embodiments, the electronic apparatus may further include a processing unit, which may correspond to the processor or processing circuit. The processing unit may be configured for reading a first boot variable from the first storage medium when the first operating system is started, reading a second boot variable from a second storage medium, determining whether the first boot variable and the second boot variable are consistent, and in response to determining that the first boot variable and the second boot variable are not consistent, reading the boot code of the first operating system according to the first boot variable.

For example, the processing unit may be configured for, in response to determining that the first boot variable and the second boot variable are not consistent, replacing the second boot variable in the second storage medium by the first boot variable, and reading the boot code of the first operating system according to the replaced second boot variable.

In some other embodiments, the processing unit can be further configured for, in response to determining that the first boot variable and the second boot variable are consistent, reading the boot code of the first operating system according to the second boot variable.

In the following, a specific example is described in accordance with some embodiments.

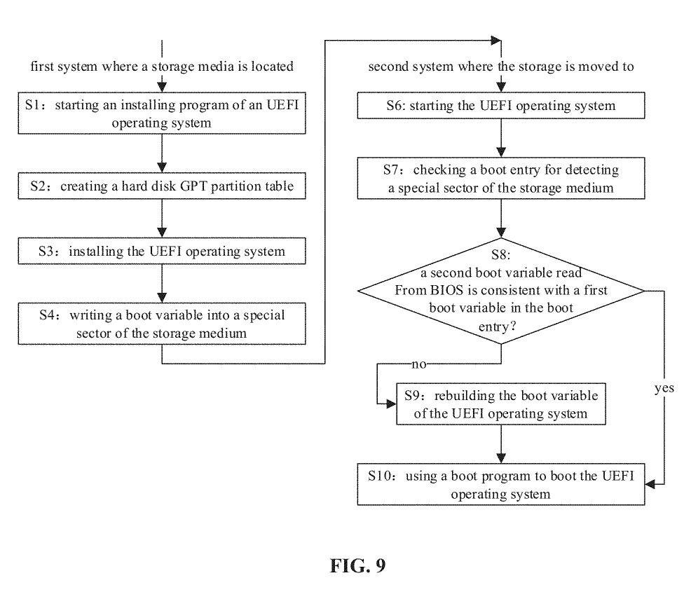

FIG. 9 illustrates a schematic flow diagram of another exemplary method for information processing in accordance with some other embodiments of the present disclosure.

The specific example can provide a method for information processing.

The method may include two phases.

In the first phase, a storage medium is located in a first system.

At S1, an installing program of an UEFI operating system (OS) is started.

At S2, a hard disk GPT partition table is created.

At S3, the UEFI operating system is installed.

At S4, a boot variable is written into a special sector of the storage medium.

In some specific implementations, the special sector may be any sector of the storage medium. In order to facilitate the subsequent reading operations of the electronic device, the storage address of the boot variable can also be written into a partition entry of a partition. The special sector may be any sector of the partition, such as the first sector or the last sector of the partition. As such, the reading of the boot variable by an electronic apparatus can be facilitated.

In the second phase, the storage medium is moved to a second system.

At S6, the UEFI operating system is powered on to start.

At S7, a boot entry is checked for detecting a special sector of the storage medium.

At S8, the system determines whether a second boot variable read from BIOS is consistent with a first boot variable in the boot entry. In response to determining that the second boot variable read from BIOS is consistent with the first boot variable in the boot entry, the method goes to S10. Otherwise, the method goes to S9.

At S9, the boot variable of the UEFI operating system is rebuilt. That is, the first boot variable in the boot entry of the special sector is written to the BIOS's memory.

At S10, the UEFI operating system is booted by using a boot program.

The boot program is the boot code described above.

Accordingly, an information processing method, and a related storage device are provided.

It should be noted that, the disclosed method, and electronic apparatus may be implemented in other ways. The embodiments described above are merely illustrative. For example, the division of the units is only based on logical functions. In some actual implementations there may be other division approaches. For example, multiple units or components may be combined, or can be integrated into another system. Some features can be ignored or not be executed. In addition, the coupling, direct coupling, or communication connection of the components shown or described may be realized by electrical or mechanical indirect couplings or communication connections through a number of interfaces, devices or units, or in other forms.

The units described above as separated components may or may not be physically separated. The component for display may or may not be a physical unit. That is, the component for display may be located in one place or may be distributed over a plurality of network elements. A part or all of the elements may be selected according to the actual needs to achieve the purpose of the present disclosure.

In addition, all of the functional units in the disclosed embodiments may be integrated in one processing unit, or each of the functional units may be used as a unit alone, or two or more units may be integrated in one unit. The integrated unit can be achieved in a form of hardware, or in a form of a functional unit combined by hardware and software.

It should be understood by those of ordinary skill in the art that, all or part of the steps of implementing the method embodiments described above may be accomplished by hardware associated with program instructions. The program instructions may be stored in a computer-readable storage medium that, when executed, the steps of the method embodiments described above can be performed. The computer-readable storage medium can include various functions such as a mobile storage device, a read-only memory (ROM), a random access memory (RAM), a disk, an optical disk, or any other suitable media that can store program code.

Alternatively, the above-described integrated units of the present disclosure may be stored in a computer-readable storage medium if it is implemented in a form of a software functional module and is sold or used as a separate product. Thus, the technical solution of the embodiments of the present disclosure may be embodied in the form of a software product. The software product can be stored in a storage medium including a number of instructions for controlling a computer device (which may be a personal computer, a server, or a network device, etc.) to perform all or part of the method described in each of the embodiments of the present disclosure. The storage medium can include a removable storage device, a ROM, a RAM, a magnetic disk, an optical disk, or any other suitable media that can store program code.

The provision of the examples described herein (as well as clauses phrased as “such as,” “e.g.,” “including,” and the like) should not be interpreted as limiting the disclosure to the specific examples; rather, the examples are intended to illustrate only some of many possible aspects.

Although the present disclosure has been described and illustrated in the foregoing illustrative embodiments, it is understood that the present disclosure has been made only by way of example, and that numerous changes in the details of embodiment of the present disclosure can be made without departing from the spirit and scope of the present disclosure. Features of the disclosed embodiments can be combined and rearranged in various ways. Without departing from the spirit and scope of the present disclosure, modifications, equivalents, or improvements to the present disclosure are conceivable to those skilled in the art and are intended to be encompassed within the scope of the present disclosure.

What is claimed is:

1. An information processing method, comprising:
installing a first operating system on an electronic apparatus;
generating a first boot variable based on a boot code corresponding to the first operation system; and
storing the first boot variable and the boot code in a first removable storage medium of the electronic apparatus.

2. The method of claim 1, wherein storing the first boot variable and the boot code on the first removable storage medium includes:
writing a storage address of the first boot variable into a partition entry of a partition of a plurality of partitions of the first removable storage medium; and
writing the first boot variable at a storage location corresponding to the storage address of the partition.

3. The method of claim 2, wherein:
writing the storage address of the first boot variable into the partition entry of the partition of the plurality of partitions of the first removable storage medium includes writing sector indication information indicating a sector for storing the first boot variable into the partition entry of the partition; and
writing the first boot variable at the storage location corresponding to the storage address of the partition includes writing the first boot variable into the sector corresponding to the sector indication information.

4. The method of claim 3, wherein:
writing the storage address of the first boot variable into the partition entry of the partition of the plurality of partitions of the first removable storage medium includes writing sector indication information indicating a sector for storing the first boot variable into attribute bytes of the partition entry of the partition.

5. The method of claim 2, wherein:
the partition includes a boot entry;
the boot entry includes storage path bytes and system name bytes; and
writing the first boot variable at the storage location corresponding to the storage address of the partition includes:
storing a storage path in the storage path bytes, and
storing a system name in the system name bytes.

6. The method of claim 5, wherein:
the boot entry further includes storage partition bytes;
writing the first boot variable at the storage location corresponding to the storage address of the partition further includes storing a partition identifier of the partition in the storage partition bytes.

7. The method of claim 5, wherein:
the boot entry further includes storage path length bytes and system name length bytes;
writing the first boot variable at the storage location corresponding to the storage address of the partition further includes:
storing a required number of bytes for the storage path into the storage path length bytes, and
storing a required number of bytes for the system name into the system name length bytes.

8. The method of claim 5, wherein:
the boot entry further includes start identification bytes and check bytes;
writing the first boot variable at the storage location corresponding to the storage address of the partition further includes:
storing a start identifier into the start identification bytes, and
storing a check code for data stored into the boot entry in the check bytes.

9. The method of claim 1, further comprising:
during starting of the first operating system, reading the first boot variable from the first removable storage medium;
reading a second boot variable from a second storage medium;
determining whether the first boot variable is consistent with the second boot variable;
reading the boot code of the first operating system according to the first boot variable, in response to determining that the first boot variable is not consistent the second boot variable; and
reading the boot code of the first operating system according to the second boot variable, in response to determining the first boot variable is consistent the second boot variable.

10. The method of claim 9, wherein reading the boot code of the first operating system according to the first boot variable includes:
in response to determining that the first boot variable is not consistent the second boot variable, replacing the second boot variable in the second storage medium by the first boot variable; and
reading the boot code of the first operating system according to the replaced second boot variable.

11. An electronic apparatus, comprising:
a processor; and
a first removable storage medium connected to the processor;
wherein the processor is configured for:
installing a first operating system on the electronic apparatus,
generating a first boot variable based on a boot code corresponding to the first operation system, and
storing the first boot variable and the boot code on the first removable storage medium.

12. The electronic apparatus of claim 11, wherein:
the first removable storage medium includes a plurality of partitions; and
the processor is further configured for:
writing a storage address of the first boot variable into a partition entry of a partition of the plurality of partitions of the first removable storage medium, and
writing the first boot variable at a storage location corresponding to the storage address of the partition.

13. The electronic apparatus of claim 12, wherein:
a partition table is stored on the first removable storage medium; and
the processor is further configured for:
writing sector indication information indicating a sector for storing the first boot variable into the partition entry of the partition, and
writing the first boot variable into the sector corresponding to the sector indication information.

14. The electronic apparatus of claim 13, wherein:
the partition entry of the partition includes attribute bytes; and
the processor is further configured for writing sector indication information indicating a sector for storing the first boot variable into the attribute bytes of the partition entry of the partition.

15. The electronic apparatus of claim 12, wherein:
the partition includes a boot entry;
the boot entry includes storage path bytes and system name bytes; and
the processor is further configured for:
storing a storage path into the storage path bytes, and
storing a system name into the system name bytes.

16. The electronic apparatus of claim 15, wherein:
the boot entry further includes storage partition bytes; and
the processor is further configured for storing a partition identifier of the partition into the storage partition bytes.

17. The electronic apparatus of claim 15, wherein:
the boot entry further includes storage path length bytes and system name length bytes; and
the processor is further configured for:
storing a required number of bytes for a storage path into the storage path length bytes, and
storing a required number of bytes for a system name into the system name length bytes.

18. The electronic apparatus of claim 15, wherein:
the boot entry further includes start identification bytes and check bytes; and
the processor is further configured for:
storing a start identifier into the start identification bytes, and
storing a check code for data stored in the boot entry into the check bytes.

19. The electronic apparatus of claim 11, wherein:
the memory further includes a second storage medium coupled with the processer; and
the processor is further configured for:
during starting of the first operating system, reading the first boot variable from the first removable storage medium,
reading a second boot variable from a second storage medium,
determining whether the first boot variable is consistent with the second boot variable,
in response to determining that the first boot variable is not consistent the second boot variable, reading the boot code of the first operating system according to the first boot variable, and
in response to determining that the first boot variable is consistent, the second boot variable, reading the boot code of the first operating system according to the second boot variable.

20. The electronic apparatus of claim 19, wherein the processor is further configured for:
in response to determining that the first boot variable is not consistent the second boot variable, replacing the second boot variable in the second storage medium by the first boot variable; and
reading the boot code of the first operating system according to the replaced second boot variable.
